(19) United States
(12) Patent Application Publication
(10) Pub. No.: US 2005/0025477 A1
(43) Pub. Date: Feb. 3, 2005

(54) Stop apparatus, a lens and a video camera having the stop apparatus

(76) Inventors: Yuko Watanabe, Saitama-Shi (JP); Yuichi Muramatsu, Saitama-Shi (JP); Seigo Nakai, Saitama-Shi (JP)

Correspondence Address: JACOBSON HOLMAN PLLC, 400 SEVENTH STREET N.W., SUITE 600, WASHINGTON, DC, 20004, US

(21) Appl. No.: 10/900,419

(22) Filed: Jul. 28, 2004

(30) Foreign Application Priority Data
Jul. 31, 2003 (JP) 2003-204806

(51) Int. Cl. G03B 9/08

(52) U.S. Cl. 396/450

(57) ABSTRACT

There is provided a stop apparatus which does not cause the reduction of resolving power and does not cause unevenness of amount of light in an imaging plane even when it is an object of very high intensity. The stop apparatus of the present invention comprises an upper blade 210, a first ND filter 216 mounted on an aperture of the upper blade 210, a lower blade 220, a second ND filter 226 mounted on an aperture of the lower blade 220, a stop unit plate 230 movably supporting the upper and lower blades 210 and 220, and a galvanometer 240 for linearly driving the upper blade 210 in a first direction and for linearly driving the lower blade 220 in a second direction opposite to the first direction. The ray transmittance of the first ND filter 216 is different from that of the second ND filter 226 so as to prevent reduction of the contrast of object with reference to other object situated at a distance different from the object distance of the focused object.

### BACKGROUND OF THE INVENTION

1. Field of the Invention

The present invention relates generally to a stop apparatus used for lens systems of optical instruments such as a video camera etc., and more particularly to a stop apparatus in which an optical filter is mounted on each of two stop blades having a notch for controlling an amount of light. In addition the present invention relates to a lens for a video camera into which the stop apparatus is incorporated. Furthermore, the present invention relates to a video camera having said lens.

2. Description of Background Art

In usual a stop apparatus having two stop blades called as a Galvano type is used for a lens for a video camera such as a conventional monitoring camera. In these stop apparatus, an ND filter (neutral density filter) is stuck on at least one of the stop blades. The two-blade type stop apparatus is disclosed for example in Patent Document 1 noticed below. In the field of monitoring, a high sensitivity monitoring camera is often used since photographing of objects has to be carried out day and night by the monitoring camera. In many cases, the high sensitivity camera uses a lens having a remarkably small minimum stop value such as F/360 in order to be accommodated to a difference in amount of light of objects in day and night.

In recent video cameras, it is necessary to reduce the diameter of stop aperture in a case of photographing high intensity objects due to the tendency of popularization of imaging elements having high sensitivity. There would be caused a problem that the resolving power is reduced due to generation of the diffraction effect of the stop aperture when the diameter of the stop aperture is extremely reduced. In order to solve this problem, the notched portion of either one of two stop blades in the stop apparatus having two stop blades is provided with the ND filter covering the bottom of the notched portion for reducing the ray transmittance as previously described. However, a portion of the imaging plane is darkened when the stop is stopped down if the ray transmittance of the ND filter is set at too low value in order to avoid an influence of the diffraction effect when the minimum stop value is set. Although it has been proposed an ND filter constituted such that the amount of ray transmission is reduced from the edge of the stop blade toward the edge of the notched portion in order to prevent generation of the diffraction effect, there are also caused a new problem that the configuration of the ND filter is complicated and thus manufacture of the ND filter is difficult.

Under the circumstances, there have been proposed many stop apparatus each having a structure in which the ND filter for reducing the ray transmittance is mounted so that it covers the bottom of the notched portion of two stop blades. The arrangement of the ND filter at the bottom of the notched portion of two stop blades makes it possible to sufficiently stop down the amount of light by a relatively large stop aperture because of the stop aperture being covered by two ND filters. This also makes it possible to suppress the influence of diffraction effect caused by the stop aperture.

However, if two ND filters having same density are mounted on the bottom of notched portions of two stop blades, there would be caused, in a ray transmittable region formed by notched portions of two stop blades, three distinct regions, i.e. a region in which two ND filters are overlapped, a region in which there is only one ND filter and a region in which no ND filter exists and thus the ray can pass without any obstruction, at a time just before the stop aperture is covered by two ND filters during the stop is stopped down. Under the circumstances, there would be caused a problem that the resolving power is reduced (i.e. the contrast of an object is reduced) due to influence of the diffraction effect. In order to prevent this problem, there have been proposed several ND filters in which the amount of ray transmission is reduced toward the aperture of the stop (see Patent Document 1 shown below). However the problem that the configuration of the ND filter is complicated and thus manufacture of the ND filter is difficult is still remained in this arrangement.

Patent Document: Japanese Laid-open Patent Publication No. 43878/1996 (Pages 2 through 3, and FIGS. 1 through 6)

### SUMMARY OF THE INVENTION

It is, therefore, an object of the present invention to provide a stop apparatus which does not cause the reduction of resolving power (reduction of contrast of an object) and does not cause unevenness of amount of light in an imaging plane even when it is an object of very high intensity.

It is another object of the present invention to provide a stop apparatus which can be manufactured easily and at a low cost.

It is another object of the present invention to provide a lens for an optical instrument into which the stop apparatus having characteristic features mentioned above is incorporated.

It is further object of the present invention to provide a video camera having a lens into which the stop apparatus having characteristic features mentioned above is incorporated.

A stop apparatus for controlling an amount of passing light of luminous flux from an object passing through an imaging lens of the present invention comprises a first stop blade having a first stop aperture for controlling the amount of passing light of luminous flux from the object; a first optical filter mounted on a portion of the first stop aperture of the first stop blade; a second stop blade having a second stop aperture for controlling the amount of passing light of luminous flux from the object; a second optical filter mounted on a portion of the second stop aperture of the second stop blade; a support member for supporting the first and second stop blades to be linearly movable; an actuator for linearly driving the first stop blade in a first direction and for linearly driving the second stop blade in a second direction opposite to the first direction (e.g. an actuator which can linearly drive the first stop blade downward and simultaneously, linearly drive the second stop blade upward, and then can linearly drive the first and second stop blades respectively to opposite directions).

In the stop apparatus of the present invention mentioned above, it is a characteristic feature that the ray transmittance of the first optical filter is different from that of the second optical filter so as to prevent a reduction of contrast of other objects situated at a distance different from the object distance of the focused object (“object distance” means a distance from a camera to an object as to the focused (i.e. in-focus) object).

According to such an arrangement, it is possible to prevent the reduction of resolving power (reduction of contrast of an object) and generation of unevenness of amount of light in an imaging plane.

It is preferable to constitute the stop apparatus of the present invention so that there is a difference in the ray transmittance more than 1.5 times between the first optical filter and the second optical filter. According to this arrangement, it is possible to realize a stop apparatus which can be manufactured easily and at a low cost.

It is preferable to constitute the stop apparatus of the present invention so that the ray transmittances of the first and second optical filters are set so that a relative minimum value of MTF adjacent to a relative maximum value of MTF at a position at which an amount of defocusing is not zero (0) becomes a value 15% or more larger than said relative maximum value of MTF. According to this arrangement, it is possible to realize a stop apparatus which can be manufactured easily and at a low cost.

It is preferable to constitute the stop apparatus of the present invention so that the configuration of an edge forming the stop aperture of the first and/or second optical filter(s) is concave.

In addition, it may be possible to constitute the stop apparatus of the present invention so that one of the configurations of edges forming the stop apertures of the first and second optical filters is concave and the other is straight.

Furthermore, it is preferable to constitute the stop apparatus of the present invention so that the first and/or second optical filter(s) is formed by an ND filter.

Also according to the stop apparatus of the present invention, it is preferable to constitute the stop apparatus of the present invention so that the first and second optical filters are partially overlapped when the stop apparatus is largely stopped down. According to this arrangement, it is possible to realize a stop apparatus which can be manufactured easily and at a low cost.

In addition, there is provided according to the present invention, a lens of an optical instrument comprising a stop apparatus of mentioned above for controlling an amount of passing light of luminous flux from an object passing through an imaging lens. According to this arrangement, it is possible to realize a lens for an optical instrument having a stop apparatus constituted so that it does not cause the reduction of resolving power (reduction of contrast of an object) and does not cause unevenness of amount of light in an imaging plane.

Furthermore, according to the present invention, there is provided a video camera comprising an imaging lens for imaging a luminous flux from an object; a camera body for recording the luminous flux from the object passing through the imaging lens; a stop apparatus mentioned above for controlling an amount of passing light of the luminous flux from the object passing through the imaging lens.

According to this arrangement, it is possible to realize a video camera having a lens for an optical instrument comprising a stop apparatus constituted so that it does not cause the reduction of resolving power (reduction of contrast of an object) and does not cause unevenness of amount of light in an imaging plane.

Summing up the effects of the present invention, the stop apparatus of the present invention does not cause the reduction of resolving power (reduction of contrast of an object) and does not cause unevenness of amount of light in an imaging plane.

It is possible to provide a stop apparatus which can be manufactured easily and at a low cost.

In the lens for a video camera having the stop apparatus of the present invention as well as a video camera provided with the lens having the stop apparatus of the present invention, they do not cause the reduction of resolving power (reduction of contrast of an object) and do not cause unevenness of amount of light in an imaging-plane.

### BRIEF DESCRIPTION OF THE DRAWINGS

Additional advantages and features of preferred embodiments of the present invention will become apparent from the subsequent description and the appended claims, taken in conjunction with the accompanying drawings, wherein:

FIG. 1 is a schematic cross-section view showing a first embodiment of the present invention;

FIG. 2 is a front elevation view of a stop apparatus of the first embodiment of the present invention;

FIG. 3 is a front elevation view of an upper stop blade of the stop apparatus of the first embodiment of the present invention:

FIG. 4 is a front elevation view of a lower stop blade of the stop apparatus in the first embodiment of the present invention:

FIGS. 5(a) through (d) are views showing the change of configuration of the stop aperture at each stop opening in the stop apparatus in the first embodiment of the present invention;

FIG. 6 is a three dimension graph showing the distribution of an amount of ray transmission through the stop apparatus at the stop opening of FIG. 5(d);

FIG. 7 is a graph showing the MTF defocusing characteristics of 10/mm in a case in which the stop apparatus having the distribution of amount of ray transmission shown in FIG. 6 is mounted on a lens;

FIG. 8 is a front elevation view showing a stop apparatus according to a second embodiment of the present invention;

FIGS. 9(a) through (d) are views showing the change of configuration of the stop aperture at each stop opening in the stop apparatus of the second embodiment of the present invention;

FIG. 10 is a front elevation view showing a stop apparatus according to a first comparative example;

FIGS. 11(a) through (d) are views showing the change of configuration of the stop aperture at each stop opening in the stop apparatus in the first comparative example;

FIG. 12 is a three dimension graph showing the distribution of an amount of ray transmission through the stop apparatus at the stop opening of FIG. 11(c);

FIG. 13 is a graph showing the MTF defocusing characteristics of 10/mm in a case in which the stop apparatus having the distribution of amount of ray transmission shown in FIG. 12 is mounted on a lens;

FIGS. 14(a) through (d) are views showing the change of configuration of the stop aperture at each stop opening in the stop apparatus in a second comparative example;

FIG. 15 is a three dimension graph showing the distribution of an amount of ray transmission through the stop apparatus at the stop opening of FIG. 14(d);

FIG. 16 is a graph showing the MTF defocusing characteristics of 10/mm in a case in which the stop apparatus having the distribution of amount of ray transmission shown in FIG. 15 is mounted on a lens; and

FIGS. 17(a) through (j) are graphs showing the MTF defocusing characteristics of 10/mm in a case in which the stop apparatus respectively of the second comparative example, the first comparative example, and the first embodiment of the present invention is mounted on a lens.

### DESCRIPTION OF THE PREFERRED EMBODIMENTS

The preferred embodiment of the present invention will be described with reference to a monitoring camera having a stop apparatus comprising linearly driven stop blades. A term “video camera” herein means any camera including a monitoring camera, a portable video camera, and a video camera for business use.

### (1) First Embodiment

A first embodiment of the present invention will be hereinafter described.

(1•1) Structure of a Monitoring Camera

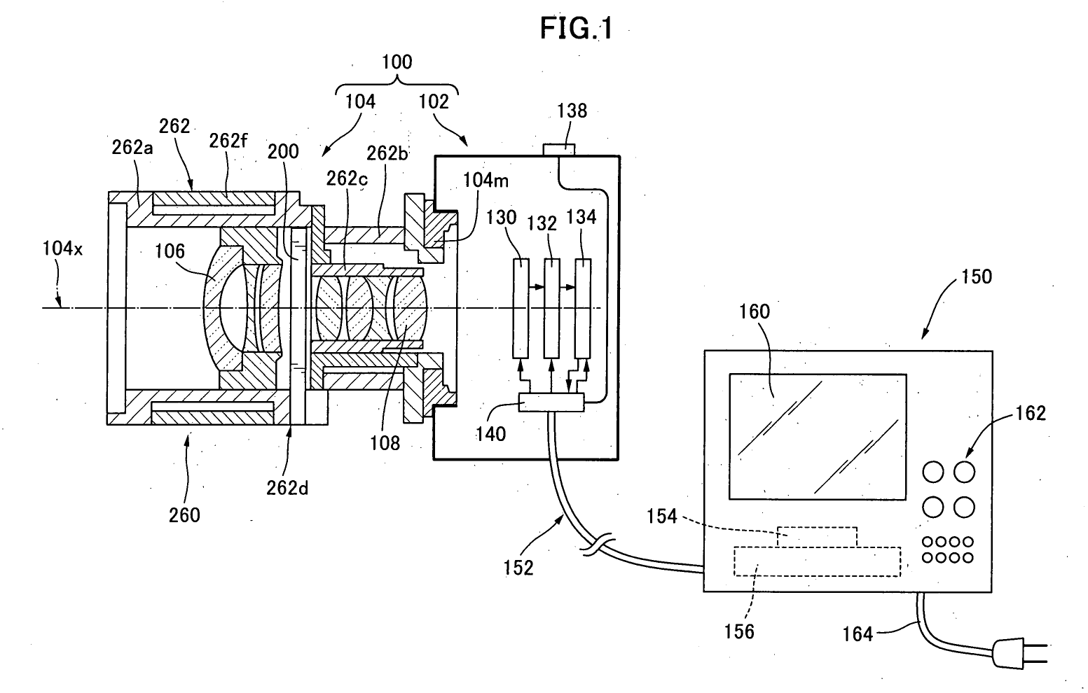

Firstly, the first embodiment of the present invention will be described with reference to the structure of the monitoring camera. As shown in FIG. 1, the monitoring camera 100 of the present invention comprises a camera body 102 for recording an image formed by luminous flux from an object, and an imaging lens 104 for leading the luminous flux from the object. The imaging lens 104 is detachably mounted on the camera body 102 via a lens mount 104m. As one modification, the imaging lens 104 may be rigidly secured on the camera body 102. The imaging lens 104 comprises an optical axis 104x of the imaging lens 104, an optical system of front group 106, an optical system of rear group 108, and a stop apparatus 200. The rear group optical system 108 constitutes a focus lens system arranged movably along the optical axis 104x of the imaging lens 104. In such a focus lens system, it is usual that the front group optical system 106 and/or rear group optical system 108 are movable.

The imaging lens 104 further comprises lens barrel elements 262. The lens barrel elements 262 comprises a first cylinder 262a, a second cylinder 262b, a lens frame 262c for supporting the rear group optical system 108, a stop apparatus introducing portion 262d, and a focus adjusting ring 262f The rear optical system 108 can be moved by rotating the focus adjusting ring 262f. It may be also possible to constitute so that the front group optical system 106 and/or the rear group optical system 108 are (or is) moved by rotating the focus adjusting ring 262f. The front group optical system 106 and the rear group optical system 108 may be supported by a known structure for example shown in the Patent Document 1 mentioned above. The stop apparatus 200 can be inserted into the stop apparatus introducing portion 262d vertically to the optical axis 104x. The stop apparatus 200 is positioned within the lens barrel elements 262 so that the central axis of the stop apparatus 200 corresponds to that of the lens barrel elements 262.

There are arranged within the camera body 102 solid-state imaging elements 130 for converting an image of object formed by the imaging lens 104 to electric signals; an electric signal processor 132 for processing electric signals relating to the image of the object outputted from the solid-state imaging elements 130; an image recording signal generator 134 for outputting signals for recording electric signals relating to the image of the object processed by the electric signal processor 132; switches 138 for controlling the monitoring camera 100; and a motion controller 140 for controlling the motion of the monitoring camera 100. The solid-state imaging elements 130 can be formed for example by CCD. The electric signal processor 132, the image recording signal generator 134, and the motion controller 140 may be constituted for example by a MOS-IC, a PLA-IC, etc.

There is provided an image recording apparatus 150 separately from the camera body 102. The image recording apparatus 150 may be constituted by a VTR recorder. The image recording apparatus 150 is connected to the camera body 102 via a connecting cord 152. The connecting cord 152 is used for supplying electric power from the image recording apparatus 150 to the camera body 102 and for sending signals for controlling the motion of the monitoring camera 100 from the image recording apparatus 150 to the motion controller 140. The connecting cord 152 is also used for sending electric signals relating to the image of the object outputted from the image recording signal generator 134 of the camera body 102 to the image recording apparatus 150.

There are arranged within the image recording apparatus 150, a record processor 154 for record-processing the image of the object with inputting electric signals relating to the image of the object sent from the camera body 102, and a recording medium 156 for recording the image of the object in accordance with the operation of the record processor 154. The recording medium 156 may be constituted for example by a VTR tape, a RAM card, a flexible disc, an optical disc, an MO disc, a CD-R, a CD-RW, a DVD-RAM, a DVD-RW, etc.. The image recording apparatus 150 is provided with an image display 160 for displaying the image of the object sent from the monitoring camera 100, switches 162 for controlling the image recording apparatus 150, and an electric cord 164 for connecting the image recording apparatus 150 to a power source. The power source for driving the image recording apparatus 150 may be constituted for example by the external AC power source, an external battery, or a battery self-contained within the image recording apparatus 150. The recording medium may be arranged within the camera body 102. If necessary, the power source such as a battery may be arranged within the camera body 102. Also if necessary, any type of camera display (not shown) for displaying the image of the object may be provided on the camera body 102. It is preferable in the portable video camera and the business-use video camera, to arrange the camera display and the camera controlling parts on the camera body 102. Also it is preferable in the portable video camera, to arrange the power source such as a battery and a control circuit, etc. on the camera body 102.

(1•2) Structure of the Stop Apparatus

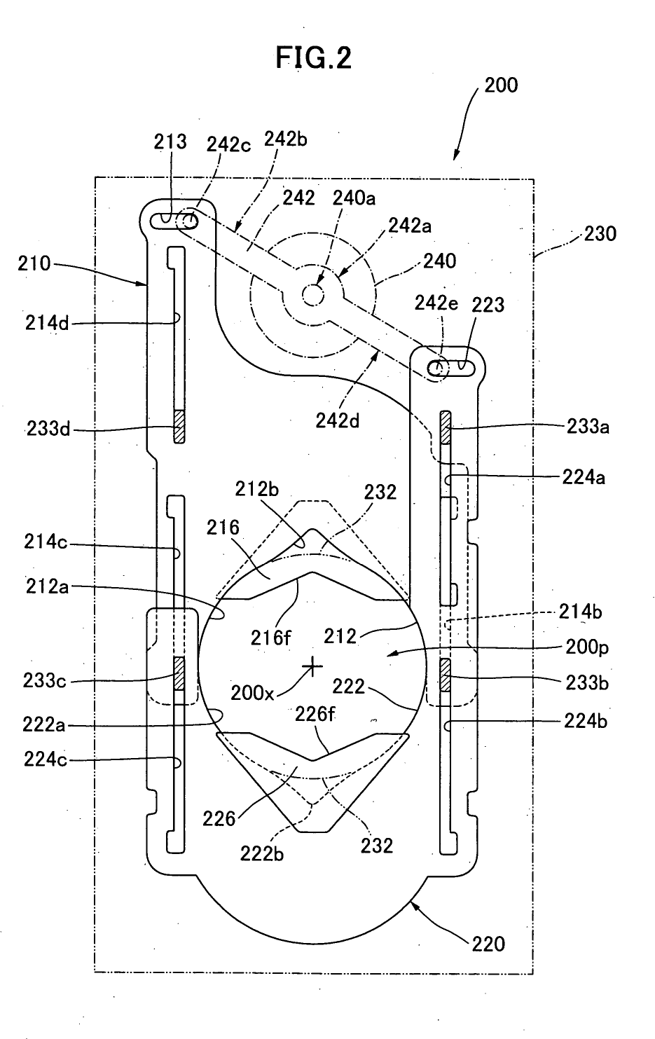

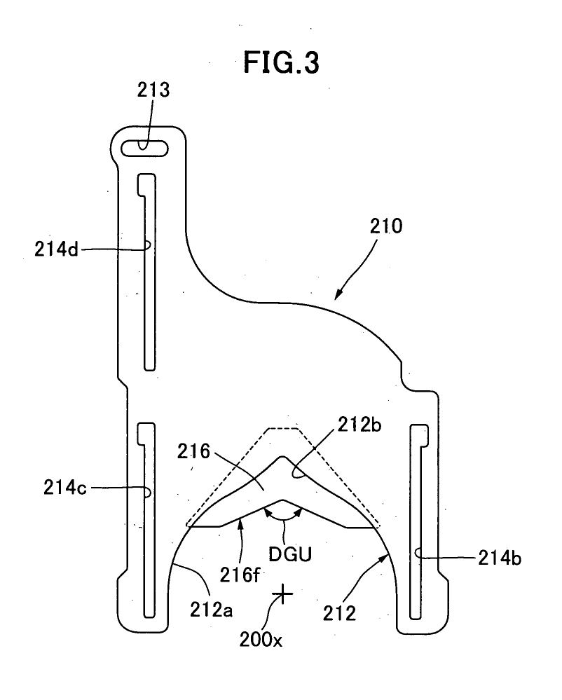

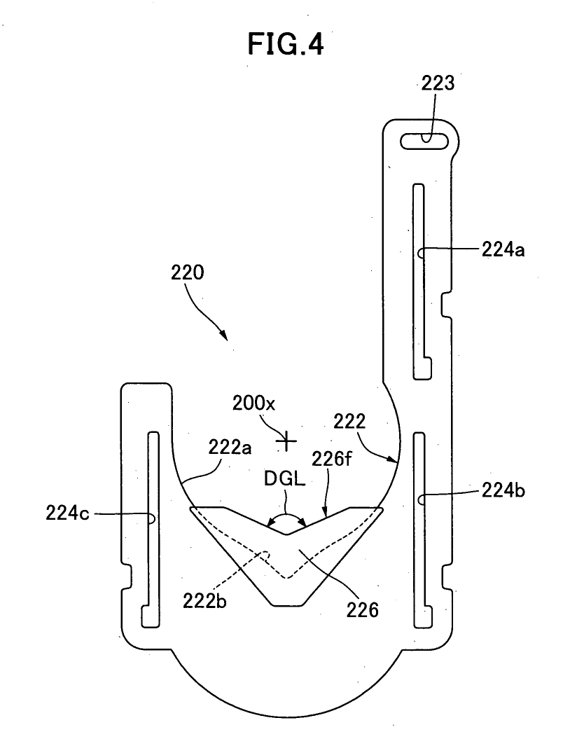

Then the structure of the stop apparatus 100 applied to the monitoring camera of the embodiment of the present invention will be described. With reference to FIGS. 2 through 4, the stop apparatus 200 comprises a first stop blade or an upper blade 210, a second stop blade or a lower blade 220, a supporting member or a stop unit plate 230 for supporting the first and second stop blades 210 and 220 to be linearly movable, and a galvanometer 240 for constituting actuator for linearly driving the upper and lower blades 210 and 220. The upper and lower blades 210 and 220 may be arranged on the same side as the galvanometer 240 or on the opposite side to the galvanometer 240 with respect to the stop unit plate 230.

The upper blade 210 is supported on the stop unit plate 230 so that it is positioned at the lowermost position in a condition of a minimum stop value and positioned at the uppermost position in a condition of a fully-opened stop value. On the other hand, the lower blade 220 is supported on the stop unit plate 230 so that it is positioned at the uppermost position in a condition of a minimum stop value and positioned at the lowermost position in a condition of a fully-opened stop value. That is, in accordance with increase of the stop opening from the minimum stop value to the fully-opened stop value, the upper blade 210 linearly moves upward and the lower blade 220 linearly moves downward.

A meter lever 242 is secured to the output portion 240a of the galvanometer 240. The meter lever 242 comprises a central portion 242a, an upper blade driving arm 242b for driving the upper blade 210, an upper blade driving pin 242c for linearly driving the upper blade 210 toward a first direction, a lower blade driving arm 242d for driving the lower blade 220, a lower blade driving pin 242e for linearly driving the lower blade 220 toward a second direction opposite to the first direction. When the output portion 240a of the galvanometer 240 rotates by a certain angle in one direction, the upper blade 210 is linearly driven toward the first direction by the upper blade driving pin 242c and simultaneously the lower blade 220 is linearly driven by the lower blade driving pin 242e toward the second direction opposite to the first direction. Here, when the first direction is an upward direction, the second direction is a downward direction, on the contrary, when the first direction is a downward direction, the second direction is an upward direction. That is, the first direction and the second direction are opposite each other.

The meter lever 242 is constituted so that when it is rotated to the clockwise direction viewed from a side in which the upper and lower blades 210 and 220 are arranged, the upper blade 210 is linearly driven upward and simultaneously the lower blade 220 is linearly driven downward to operate the stop apparatus toward the opening position, and so that when it is rotated to the anti-clockwise direction viewed from a side in which the upper and lower blades 210 and 220 are arranged, the upper blade 210 is linearly driven downward and simultaneously the lower blade 220 is linearly driven upward to operate the stop apparatus toward the closing position.

The stop unit plate 230 comprises a stop unit aperture 232 for passing the luminous flux from the object therethrough, a first blade guiding pin 233a for guiding the lower blade 220 so that it can linearly move, a second blade guiding pin 233b for guiding the upper and lower blade 210 and 220 so that they can linearly move, a third blade guiding pin 233c for guiding the upper and lower blade 210 and 220 so that they can linearly move, and a fourth blade guiding pin 233d for guiding the upper blade 210 so that it can linearly move. A central axis 200x of the stop unit aperture 232 is arranged so that it corresponds to the optical axis 104x of the imaging lens 104 when the stop unit plate 230 is mounted on the imaging lens 104. It is preferable that the stop unit aperture 232 includes a circular arc having its center on the central axis 200x.

The upper blade 210 comprises a first stop aperture or upper blade aperture 212 for controlling the amount of passing light of luminous flux from the object, an upper blade interlocking hole 213 for receiving the upper blade driving pin 242c, a first upper blade guiding hole 214b for receiving the second blade guiding pin 233b of the stop unit plate 230 and guiding so that the upper blade 210 can linearly move, a second upper blade guiding hole 214c for receiving the third blade guiding pin 233c of the stop unit plate 230 and guiding so that the upper blade 210 can linearly move, and a third upper blade guiding hole 214d for receiving the fourth blade guiding pin 233d of the stop unit plate 230 and guiding so that the upper blade 210 can linearly move. The upper blade aperture 212 comprises a lower portion 212a formed by circular arcs, and an upper portion 212b positioned above the lower portion 212a and formed by two lines tangential to the circular arcs forming the lower portion 212a so that they form a substantially right apex angle.

An ND filter of upper blade 216 forming a first optical filter is mounted on the upper blade 210 so that it extends across the upper portion 212b. That is, it is preferable to form the first optical filter by the ND filter. In a video camera for recording a black-and-white image, the first optical filter may be formed by a ray reduction filter (a colored filter for reducing an amount of ray transmission) such as a yellow filter (Y-filter), an orange filter (O-filter) or a red filter (R-filter). It is preferable that the upper blade ND filter 216 is ND 0.8 having the amount of ray transmission of about 16%.

It is preferable that the upper blade ND filter 216 has a configuration substantially of an isosceles triangle of which apex angle is positioned at an upper position and the base is at a lower position. A lower edge of the base or lower end face 216f of the ND filter 216 is formed as a concave configuration relative to the central axis 200x of the stop unit aperture 232. That is, a notch having a configuration of a second isosceles triangle smaller than said isosceles triangle is formed on the base of said isosceles triangle forming the upper blade ND filter 216. It is preferable that the configuration of the edge 216f of the upper blade ND filter 216 is formed as an axial symmetry with respect to a line passing through the central axis 200x and parallel with the moving direction of the upper blade 210. Also it is preferable that an apex angle DGU of the edge 216f of the upper blade ND filter 216 is 90° through 175°.

The upper blade interlocking hole 213 is formed as an elongated hole of which central axis extending horizontally. Each of the first upper blade guiding hole 214b, the second upper blade guiding hole 214c, the third upper guiding hole 214d is formed as an elongated hole of its central axis extending vertically. The upper blade interlocking hole 213 is arranged at a left-hand side relative to the upper blade aperture 212 viewing from a side at which the upper blade 210 is arranged.

The lower blade 220 comprises a second stop aperture or lower blade aperture 222 for controlling the amount of passing light of luminous flux from the object, an lower blade interlocking hole 223 for receiving the lower blade driving pin 242e of the galvanometer 240, a first lower blade guiding hole 224a for receiving the first blade guiding pin 233a of the stop unit plate 230 and guiding so that the lower blade 220 can linearly move, a second lower blade guiding hole 224b for receiving the second blade guiding pin 233b of the stop unit plate 230 and guiding so that the lower blade 220 can linearly move, and a third lower blade guiding hole 224c for receiving the third blade guiding pin 233c of the stop unit plate 230 and guiding so that the lower blade 220 can linearly move. The lower blade aperture 222 comprises an upper portion 222a formed by circular arcs, and a lower portion 222b positioned below the upper portion 222a and formed by two lines tangential to the circular arcs forming the upper portion 222a so that they form a substantially right apex angle.

An ND filter of lower blade 226 forming a second optical filter is mounted on the lower blade 220 so that it extends across the lower portion 222b. That is, it is preferable to form the second optical filter by the ND filter. In a video camera for recording a black-and-white image, the second optical filter may be formed by a ray reduction filter (a colored filter for reducing an amount of ray transmission) such as a yellow filter (Y-filter), an orange filter (O-filter) or a red filter (R-filter). It is preferable that the second filter is formed by an optical filter of same kind as the first optical filter.

It is preferable that the lower blade ND filter 226 is ND 1.2 (i.e. the density of 1.2) having the amount of ray transmission of about 6% when the upper blade ND filter 216 is ND 0.8 (i.e. the density of 0.8) having the amount of ray transmission of about 16%. In addition, it is preferable that the lower blade ND filter 226 is ND 1.4 (i.e. the density of 1.4) when the upper blade ND filter 216 is ND 0.6 (i.e. the density of 0.6). In such an arrangement, it is preferable to constitute the upper blade ND filter 216 and the lower blade ND filter 226 so that a difference of the density between the upper and lower blade ND filters 216 and 226 is larger than 0.2.

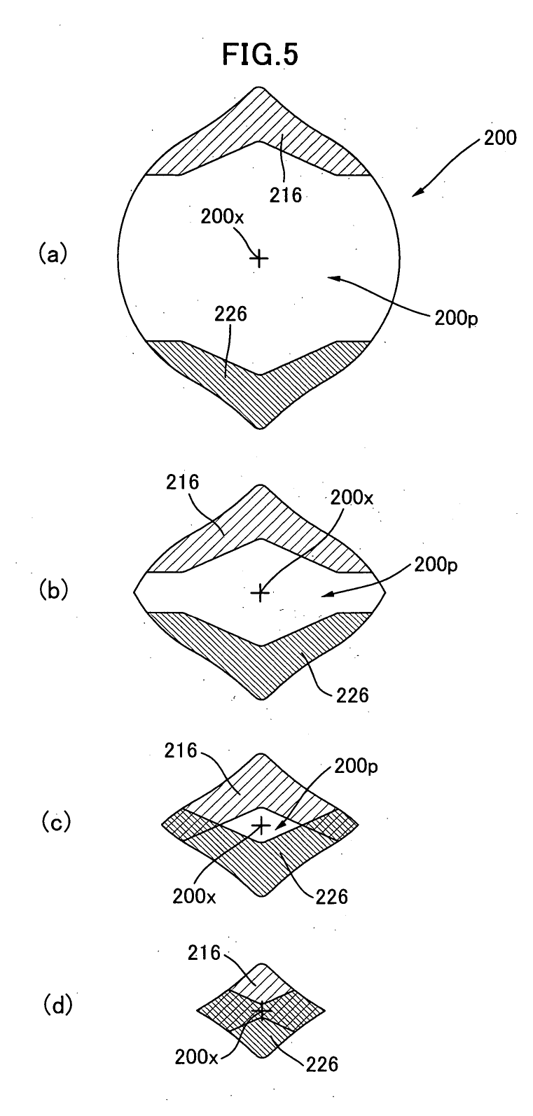

According to the preferred embodiment of the present invention, the upper and lower blade ND filters 216 and 226 are constituted so that they have different ray transmittances each other. In FIG. 5, the upper blade ND filter 216 having a low density is shown by a coarse hatching and the lower blade ND filter 226 having a high density is shown by a fine hatching.

It is preferable that the lower blade ND filter 226 has a configuration substantially of an isosceles triangle of which apex angle is positioned at a lower position and the base is at an upper position. An upper edge of the base or upper end face 226f of the ND filter 226 is formed as a concave configuration relative to the central axis 200x of the stop unit aperture 232. That is, a notch having a configuration of a second isosceles triangle smaller than said isosceles triangle is formed on the base of said isosceles triangle forming the lower blade ND filter 226. It is preferable that the configuration of the edge 216f of the upper blade ND filter 216 and the configuration of the edge 226f of the lower blade ND filter 226 are formed as an axial symmetry with respect to a line passing through the central axis 200x and parallel with the moving direction of the lower blade 220. Also it is preferable that an apex angle DGL of the edge 226f of the lower blade ND filter 226 is 90° through 175°.

It is preferable that the apex angle GDU of the edge 216f of the upper blade ND filter 216 is equal to the apex angle DGL of the edge 226f of the lower blade ND filter 226.

The lower blade interlocking hole 223 is formed as an elongated hole of which central axis extending horizontally. Each of the first lower blade guiding hole 224a, the second lower blade guiding hole 224b, the third lower guiding hole 224c is formed as an elongated hole having its central axis extending vertically. The lower blade interlocking hole 223 is arranged at a right-hand side relative to the lower blade aperture 222 viewing from a side at which the lower blade 220 is arranged. That is, a position of the lower blade interlocking hole 223 is positioned at a position opposite to that of the upper blade interlocking hole 213 with respect to the center of the lower blade aperture 222 viewing from a side at which the lower blade 220 is arranged.

In the assembled condition of the stop apparatus 200, it is constituted so that the center of the circular arc portion of the upper blade aperture 212 in the fully-opened stop condition corresponds to that of the circular arc portion of the lower blade aperture 222 in the fully-opened stop condition. Also in the assembled condition of the stop apparatus 200, it is constituted so that the center of the stop unit aperture 232 of the stop unit plate 230 corresponds both to the center of the circular arc portion of the upper blade aperture 212 in the fully-opened stop condition and to the center of the circular arc portion of the lower blade aperture 222 in the fully-opened stop condition.

(1•3) Method for Assembling the Stop Apparatus to the Monitoring Camera

Then the method for assembling the stop apparatus to the monitoring camera will be described. With reference to FIG. 1, the lens barrel 260 comprises lens barrel elements 262. The lens barrel elements 262 comprise the first cylinder 262a, the second cylinder 262b, and the stop apparatus introducing portion 262d arranged below the second cylinder 262b. The stop apparatus 200 is inserted into the stop apparatus introducing portion 262d from the lower part of the lens barrel elements 262. Alternately, it is possible to insert the stop apparatus 200 into the stop apparatus introducing portion 262d from the upper part of the lens barrel elements 262 by changing the setting direction of the lens barrel elements 262. The stop apparatus 200 is arranged within the lens barrel elements 262 so that the central axis 200x of the stop unit aperture 232 of the stop unit plate 230 of the stop apparatus 200 corresponds to the central axis of the lens barrel elements 262. The stop apparatus 200 is secured to the lens barrel elements 262 by a fastening screw (not shown).

Then the lens barrel 260 on which the stop apparatus 200 is mounted is assembled to the imaging lens 104. During which, the central axis 200x of the stop unit aperture 232 of the stop unit plate 230 of the stop apparatus 200 is arranged so that it corresponds to the optical axis 104x of the lens system 106.

(1•4) Operation of the Monitoring Camera

Then the operation of the monitoring camera 100 will be described. With reference to FIG. 1, a user can operate the CCD elements 130 by sending to the monitoring camera 100 signals for controlling the operation thereof with controlling the image recording apparatus 150. Under the circumstances, the CCD elements 130 receive the luminous flux from the object. Then the image recording signal generator 134 outputs signals for recording information relating to the image of object on the basis of the signals outputted by the CCD elements 130. Then the motion controller 140 sends electric signals relating to the image of object to the image recording apparatus 150 on the basis of signals outputted by the image recording signal generator 134. Then the record processor 154 of the image recording apparatus 150 processes to record the image of object using electric signals relating to the image of object sent from the camera body 102. The image of object is recorded in the recording medium 156 with the operation of the record processor 154 of the image recording apparatus 156. If necessary, the image display 160 of the image recording apparatus 150 can display the image of object sent from the monitoring camera 100 while recording the image of object in the recording medium 156. This arrangement enables the user to monitor the condition of object using the monitoring camera 100 and the image recording apparatus 150 and simultaneously to record the image of object.

(1•5) Operation of the Stop Apparatus

Then the operation of the stop apparatus of the first embodiment of the present invention will be described with reference to FIGS. 2 and 5. FIG. 2 shows the stop apparatus 200 set at a fully-opened value. FIG. 5(a) shows the upper blade ND filter 216 and the lower blade ND filter 226 set at the fully-opened value. FIG. 5(b) shows the upper blade ND filter 216 and the lower blade ND filter 226 in a condition set at somewhat stopped value from the fully-opened value. FIG. 5(c) shows the upper blade ND filter 216 and the lower blade ND filter 226 set at a condition further stopped down from the condition of FIG. 5(b). FIG. 5(d) shows the upper blade ND filter 216 and the lower blade ND filter 226 set at a condition further stopped down from the condition of FIG. 5(c).

When actuating the galvanometer 240 to move the upper blade 210 downward and to move the lower blade 220 upward, the configuration of the stop aperture 200p changes from FIG. 5(a) to FIG. 5(b), and further to FIG. 5(c) and thus its stop area is gradually decreased. With continuing actuation of galvanometer 240, the area of the stop aperture further decreases to a condition shown in FIG. 5(d) in which the upper blade ND filter 216 and the lower blade ND filter 226 are overlapped and no stop aperture 200p is remained.

A substantially circular stop aperture is formed by the upper blade aperture 212 of the upper blade 210 and the lower blade aperture 222 of the lower blade 220 when the stop apparatus 200 is set at the fully-opened value as shown in FIG. 5(a). Since the effective luminous flux through the stop aperture is much in its amount when the diameter of stop aperture is large in such a case of FIG. 5(a), an effect influenced by the flare generated by the upper blade ND filter 216 covering the upper end portion of the stop aperture and by the lower blade ND filter 226 covering the lower end portion of the stop aperture is little.

The configuration of the stop aperture formed by the upper blade aperture 212 of the upper blade 210 and the lower blade aperture 222 of the lower blade 220 becomes a substantially rhombus when the stop aperture is stopped down from the condition shown in FIG. 5(b) via that of FIG. 5(c) to that of FIG. 5(d). In this condition of FIG. 5(d), the amount of ray transmission through the stop aperture is further reduced since the aperture of rhombus is covered by the upper blade ND filter 216 and the lower blade ND filter 226. In the condition of FIG. 5(d), there are coexistence with a region in which only the upper blade ND filter 216 exists, a region in which only the lower blade ND filter 226 exists, and a region in which the upper blade ND filter 216 and the lower blade ND filter 226 are overlapped.

### (2) Second Embodiment

Then a second embodiment of the stop apparatus of the present invention will be described. In a following description, only a matter different from the first embodiment will be described. Accordingly matters not described herein should be applied to those previously described as to the first embodiment of the present invention.

(2•1) Structure of the Stop Apparatus

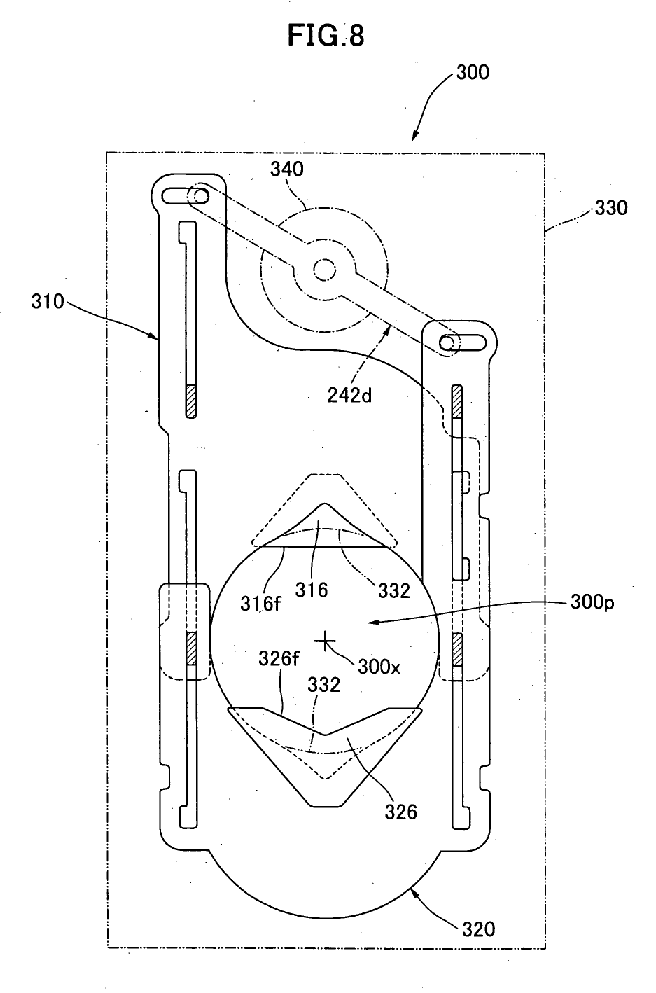

Then the structure of the stop apparatus of a second embodiment of the present invention will be described. With reference to FIG. 8, the stop apparatus 300 of the second embodiment comprises an upper blade 310, a lower blade 320, a stop unit plate 330 for supporting the upper and lower stop blades 310 and 320 to be linearly movable, and a galvanometer 340 for constituting actuator for linearly driving the upper and lower blades 310 and 320. A central axis 300x of the stop unit aperture 332 is arranged so that it corresponds to the optical axis 104x of the imaging lens 104 when the stop unit plate 330 is mounted on the imaging lens 104. The stop unit aperture 332 is formed so that it includes a circular arc having its center on the central axis 300x.

An upper blade ND filter 316 is mounted on the upper blade 310. It is preferable that the upper blade ND filter 316 is ND 1.2 having the amount of ray transmission of about 6%. It is preferable that the upper blade ND filter 316 has a configuration substantially of an isosceles triangle of which apex angle is positioned at an upper position and the base is at a lower position. It is preferable that the configuration of the edge 316f of the upper blade ND filter 316 is formed as a straight line passing through the central axis 300x and vertical to a line parallel with the moving direction of the upper blade 310.

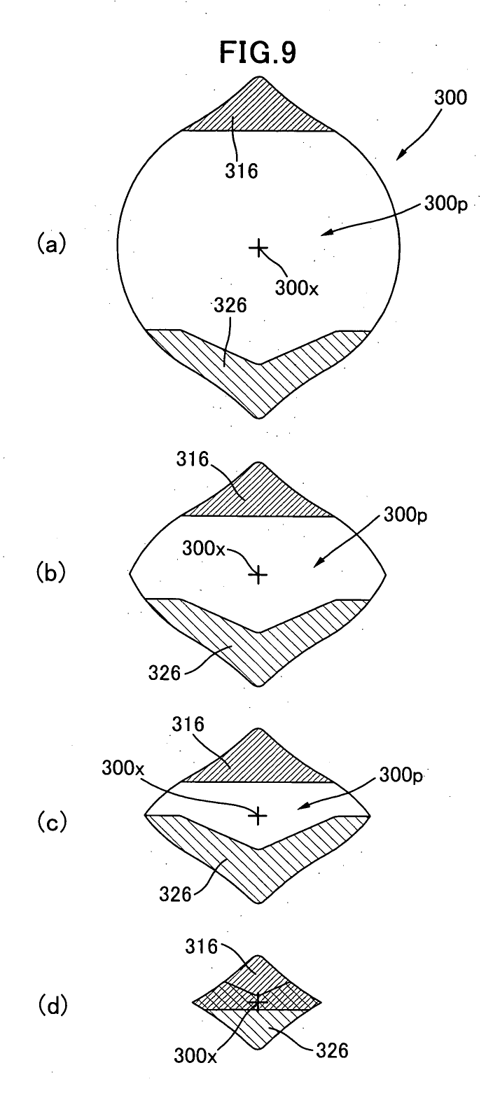

A lower blade ND filter 326 is mounted on the lower blade 320. It is preferable that the lower blade ND filter 326 is ND 0.8 when the upper blade ND filter 316 is ND 1.2. In addition, it is preferable that the lower blade ND filter 326 is ND 0.6 when the upper blade ND filter 316 is ND 1.4. In such an arrangement, it is preferable to constitute the upper blade ND filter 316 and the lower blade ND filter 326 so that a difference of the density between the upper and lower blade ND filters 316 and 326 is larger than 0.2. That is, according to the second embodiment of the present invention, the upper and lower blade ND filters 316 and 326 are constituted so that they have different ray transmittances each other. In FIG. 9, the upper blade ND filter 316 having a high density is shown by a fine hatching and the lower blade ND filter 326 having a low density is shown by a coarse hatching.

It is preferable that the lower blade ND filter 326 has a configuration substantially of an isosceles triangle of which apex angle is positioned at a lower position and the base is at an upper position. An upper edge of the base or upper end face 326f of the ND filter 326 is formed as a concave configuration relative to the central axis 300x of the stop unit aperture 332. That is, a notch having a configuration of a second isosceles triangle smaller than said isosceles triangle is formed on the base of said isosceles triangle forming the lower blade ND filter 326. It is preferable that the configuration of the edge 316f is formed as an axial symmetry with respect to a line passing through the central axis 300x and parallel with the moving direction (a same direction as the moving direction of the upper blade 310) of the lower blade 320.

(2•2) Operation of the Stop Apparatus

Then the operation of the stop apparatus of the second embodiment of the present invention will be described with reference to FIGS. 8 and 9. FIG. 8 shows the stop apparatus 300 set at the fully-opened value. FIG. 9(a) shows the upper blade ND filter 316 and the lower blade ND filter 326 set at the fully-opened value. FIG. 9(b) shows the upper blade ND filter 316 and the lower blade ND filter 326 in a condition set at somewhat stopped down value from the fully-opened value. FIG. 9(c) shows the upper blade ND filter 316 and the lower blade ND filter 326 set at a condition further stopped down from the condition of FIG. 9(b). FIG. 9(d) shows the upper blade ND filter 316 and the lower blade ND filter 326 set at a condition further stopped down from the condition of FIG. 9(c).

When actuating the galvanometer 340 to move the upper blade 310 downward and to move the lower blade 320 upward, the configuration of the stop aperture 300p changes from FIG. 9(a) to FIG. 9(b), and further to FIG. 9(c) and thus its stop area is gradually decreased. With continuing actuation of galvanometer 340, the area of the stop aperture further decreases to a condition shown in FIG. 9(d) in which the upper blade ND filter 316 and the lower blade ND filter 326 are partially overlapped and no stop aperture 300p is remained.

A substantially circular stop aperture is formed by the upper blade aperture of the upper blade 310 and the lower blade aperture of the lower blade 320 when stop apparatus 300 is set at the fully-opened value as shown in FIG. 9(a). Since the effective luminous flux through the stop aperture is much in its amount when the diameter of stop aperture is large in such a case of FIG. 9(a), an effect influenced by the flare generated from the upper blade ND filter 316 covering the upper end portion of the stop aperture and from the lower blade ND filter 326 covering the lower end portion of the stop aperture is little.

The configuration of the stop aperture formed by the upper blade aperture of the upper blade 310 and the lower blade aperture of the lower blade 320 becomes a substantially heptagon when the stop aperture is gradually stopped down as shown in FIG. 9(b), FIG. 9(c) and FIG. 9(d). The amount of ray transmission through the stop aperture is further reduced since the aperture of heptagon is covered by the upper blade ND filter 316 and the lower blade ND filter 326. In the condition of FIG. 9(d), there are coexistence with a region in which only the upper blade ND filter 316 exists, a region in which only the lower blade ND filter 326 exists, and a region in which the upper blade ND filter 316 and the lower blade ND filter 326 are overlapped.

### (3) Applicability to an Auto-Focus Apparatus

(3•1) The Stop Apparatus of the Preferred Embodiments of the Present Invention

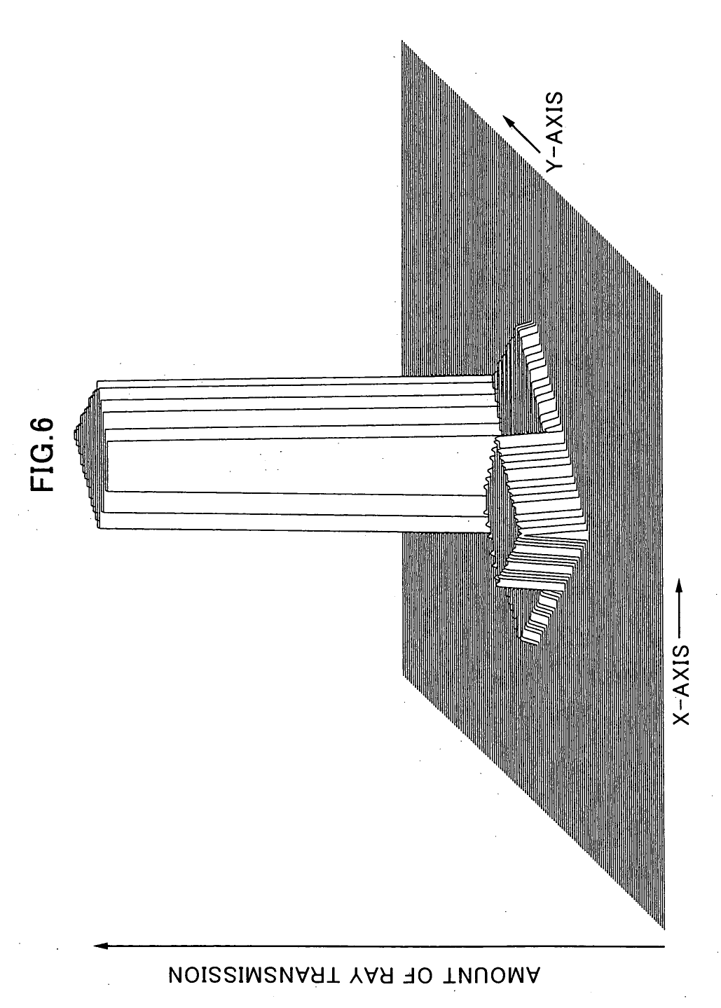

Then the applicability of the stop apparatus of the present preferred embodiments of the present invention to the auto-focus apparatus will be described. In a three dimensional graph of FIG. 6, an X-axis corresponds to the horizontal direction of FIG. 5 and a Y-axis corresponds to the vertical direction of FIG. 5. As shown in FIG. 6, the amount of ray transmission is substantially zero (0) at a portion in which rays are shielded by the upper blade aperture 212 of the upper blade 210 and the lower blade aperture 222 of the lower blade 220. The amount of ray transmittance at a portion in which rays pass only the upper blade ND filter 216 is more than that at a portion in which rays pass the lower blade ND filter 226. The amount of ray transmittance at a portion in which rays pass both the upper and lower blade ND filters 216 and 226 is lesser than that at a portion in which rays pass the lower blade ND filter 226.

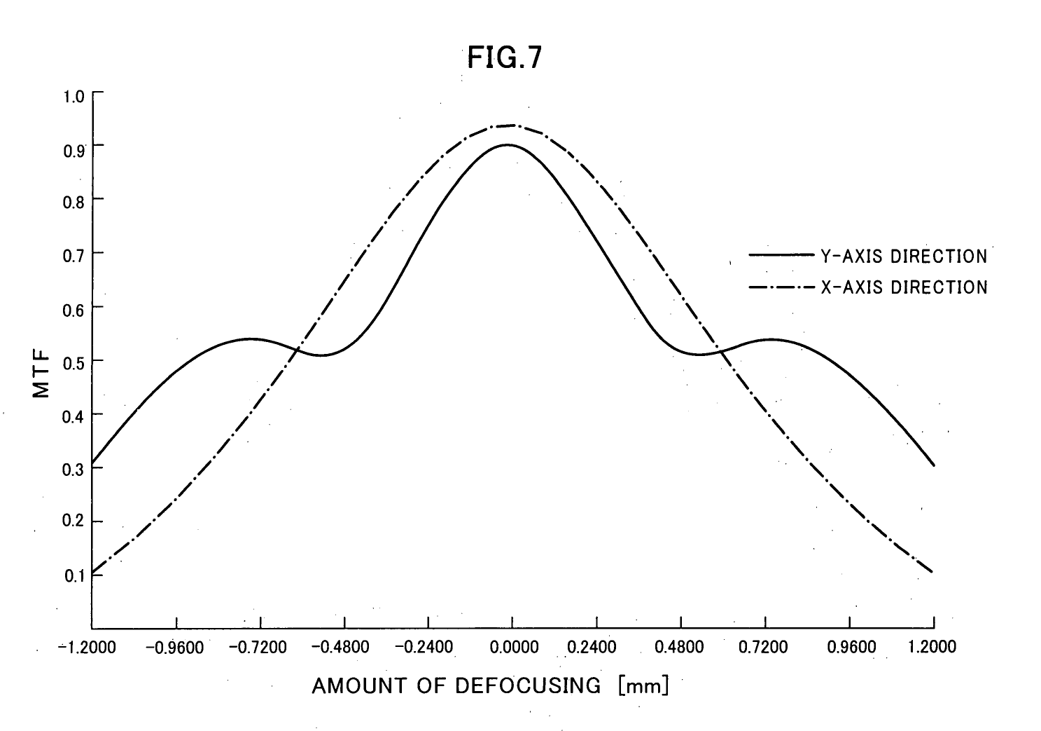

FIG. 7 is a graph showing the MTF defocusing characteristics of 10/mm in a case in which the stop apparatus having the amount distribution of ray transmission of FIG. 6 is incorporated in a video camera. This graph shows the MTF relative to each defocusing amount. The term “MTF” herein means a numerical expression of change of contrast of image when rays from an object (object having the spatial frequency contrast of “1”) are imaged through lenses.

In FIG. 7, a dashed line shows the defocusing characteristics or MTF in the X-direction and a solid line shows the defocusing characteristics or MTF in the Y-direction. As can be seen in FIG. 7, since no contrast-peak of false resolution appears in the defocusing characteristics or MTF in the X-axis direction as well as the contrast-peaks of false resolution in the defocusing characteristics or MTF in the Y-axis direction are mild, it is conceived that erroneous operation in auto-focusing will scarcely happen even if the stop apparatus of the present invention is applied to a camera having an auto-focusing apparatus of so-called a “mountain-climbing type”.

(3•2) The Stop Apparatus of a First Comparative Example

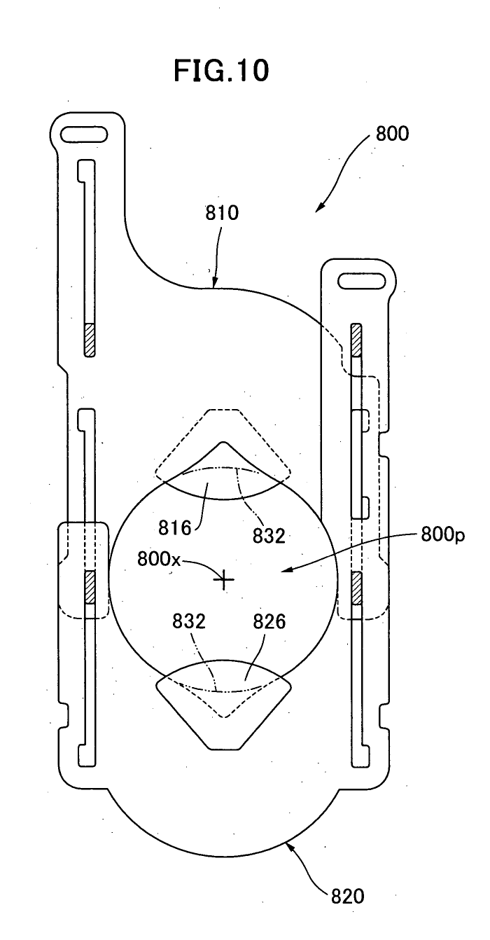

Then the stop apparatus of the first comparative example will be described. With reference to FIG. 10, the stop apparatus 800 of the first comparative example comprises an upper blade 810, a lower blade 820, a stop unit plate (not shown) for supporting the upper and lower stop blades 810 and 820 to be linearly movable, and a galvanometer (not shown) for constituting actuator for linearly driving the upper and lower blades 810 and 820. A central axis 800x of the stop unit aperture 832 is arranged so that it corresponds to the optical axis 104x of the imaging lens 104 when the stop unit plate 830 is mounted on the imaging lens 104. The stop unit aperture 832 is formed so that it includes a circular arc having its center on the central axis 800x.

An upper blade ND filter 816 is mounted on an upper blade 810. The upper blade ND filter 816 has a value of ND 1.0. The upper blade ND filter 816 has a configuration of substantially a sector. The configuration of the lower edge of the upper blade ND filter 816 is formed as a convex relative to the central axis 800x of the stop unit aperture 832.

A lower blade ND filter 826 is mounted on the lower blade 820. The lower blade ND filter 826 has a value of ND 1.0. The ray transmittance of the upper blade ND filter 816 is same as that of the lower blade ND filter 826. That is, the density of the upper blade ND filter 816 is same as that of the lower blade ND filter 826. The configuration of the edge of the upper blade ND filter 816 and the configuration of the edge of the lower blade ND filter 826 are formed as an axial symmetry with respect to a line vertical to the moving direction of the lower blade 820. Other structures of the stop apparatus 800 in the first comparative example are same as those of the stop apparatus 200 in the first embodiment of the present invention.

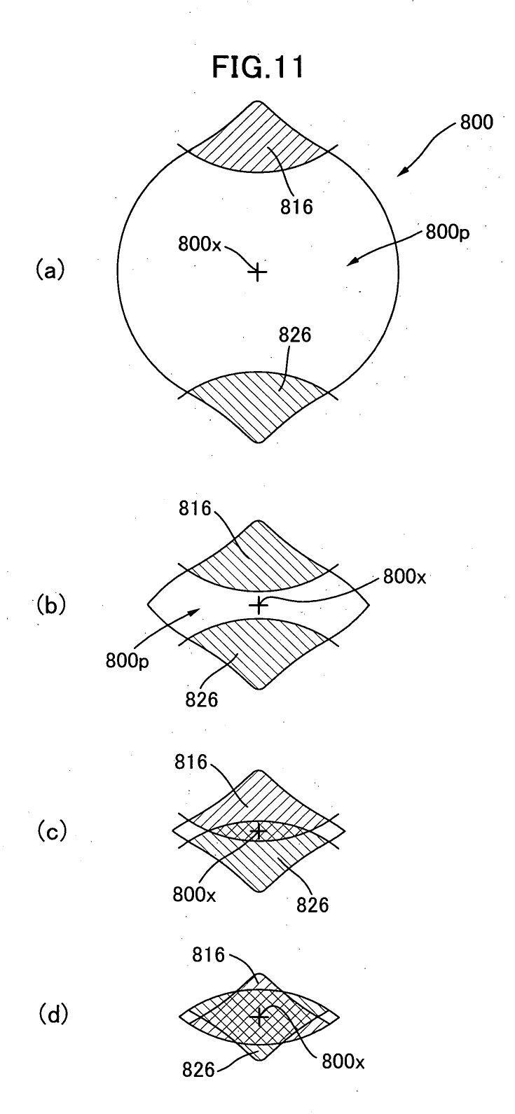

With reference to FIG. 11(a), it is shown herein a condition of the stop apparatus 800 being set at the fully-opened value. When actuating the galvanometer (not shown) to move the upper blade 810 downward and the lower blade 820 upward, the configuration of the stop aperture 800p changes from FIG. 11(a) to FIG. 11(b) and thus its stop area is gradually decreased. With continuing actuation of the galvanometer, the area of the stop aperture further decreases to a condition shown in FIG. 11(d). In the condition of FIG. 11(c), there are coexistence with a region in which only the upper blade ND filter 816 exists, a region in which only the lower blade ND filter 826 exists, a region in which the upper blade ND filter 816 and the lower blade ND filter 826 are overlapped, and a region in which no ND filter exists and thus the ray can pass without any obstruction. The last region i.e. the region in which no ND filter exists and thus the ray can pass without any obstruction exists one by one at either side of the stop aperture in the X-axis direction.

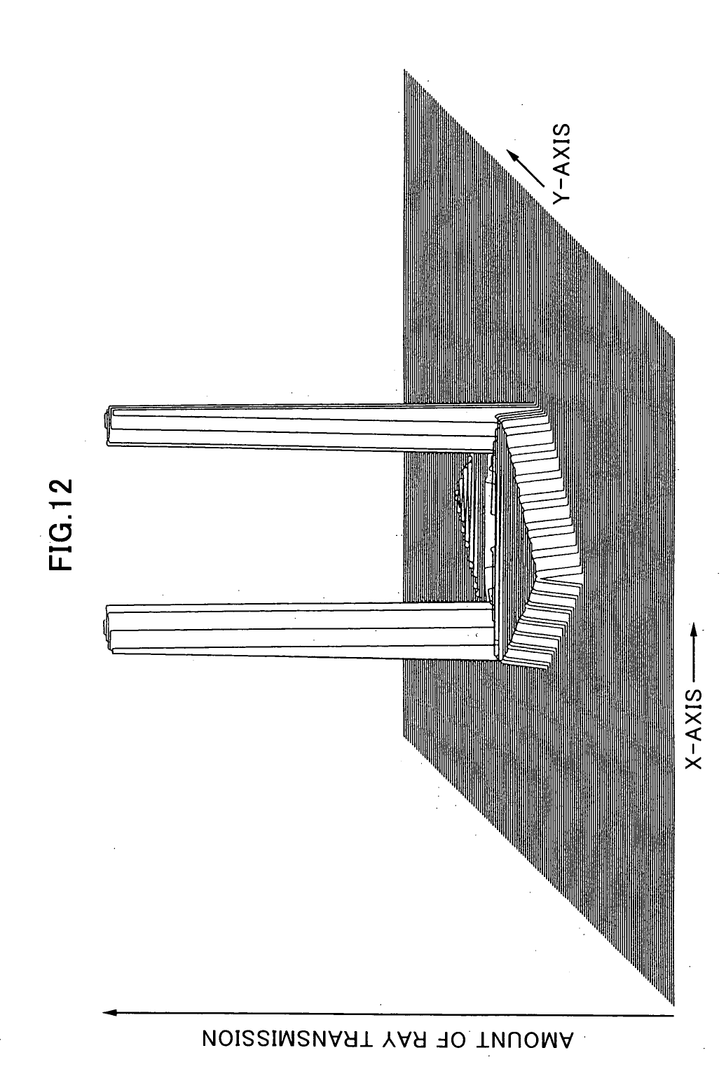

With reference to FIG. 12, it will be seen that two high intensity portions exists in the X-axis direction at the stop opening of FIG. 11(c). These high intensity portions correspond to the regions in which no ND filter exists and thus the ray can pass without any obstruction. In the condition of FIG. 11(c), the peaks of false resolution during defocusing are emphasized and thus would cause erroneous operations in focus detection of the auto-focusing apparatus.

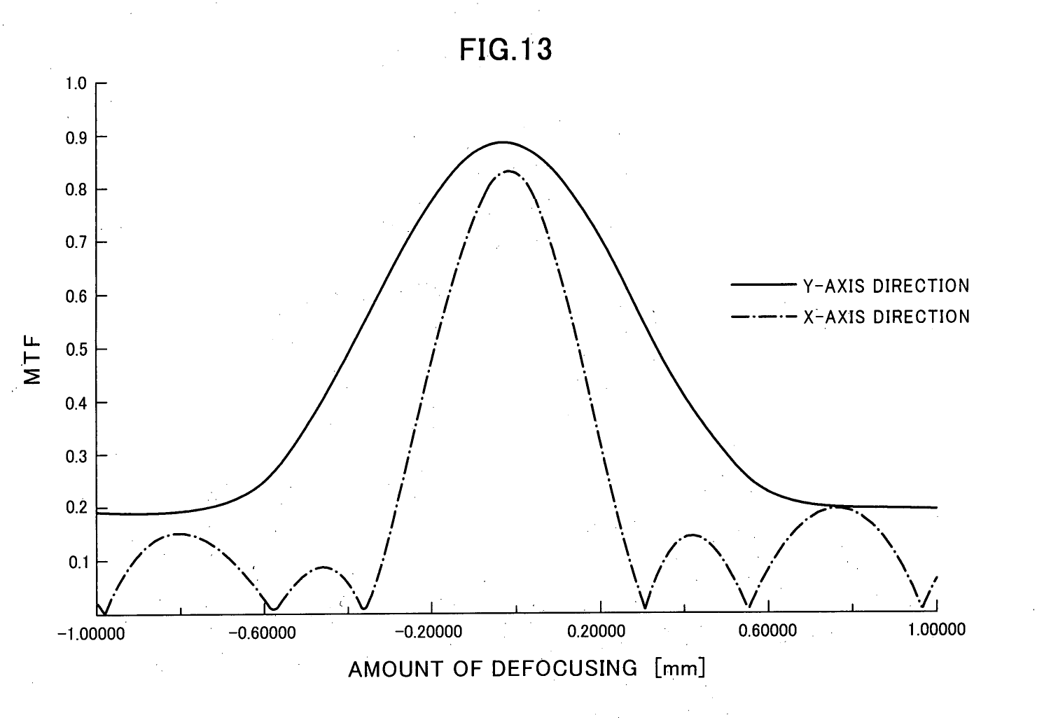

FIG. 13 is a graph showing the MTF defocusing characteristics of 10/mm in a case in which the stop apparatus having the amount distribution of ray transmission of FIG. 12 is incorporated in a video camera. This graph shows the MTF relative to each defocusing amount. In FIG. 13, a dashed line shows the defocusing characteristics or MTF in the X-direction and a solid line shows the defocusing characteristics or MTF in the Y-direction. In a case of light amount distribution of FIG. 12, contrast-peaks of false resolution appears in the defocusing characteristics or MTF in the X-axis direction. Accordingly in the graph of the defocusing characteristics or MTF, the MTF exhibits the relative maximum value in points other than a point in which the defocusing amount is zero (0). Thus in a camera having the auto-focusing apparatus of so-called a “mountain-climbing type”, it is afraid that the peaks of false resolutions are judged as focused positions and thus erroneous operation of auto-focusing would be caused. Accordingly, it is afraid that the stop apparatus 800 of the first comparative example shown in FIG. 10 would cause erroneous operation in focus detection when it is combined with the auto-focusing apparatus using the horizontal image signal of video signals (more particularly, an auto-focusing apparatus of so-called a “mountain-climbing type”).

(3•3) The Stop Apparatus of a Second Comparative Example

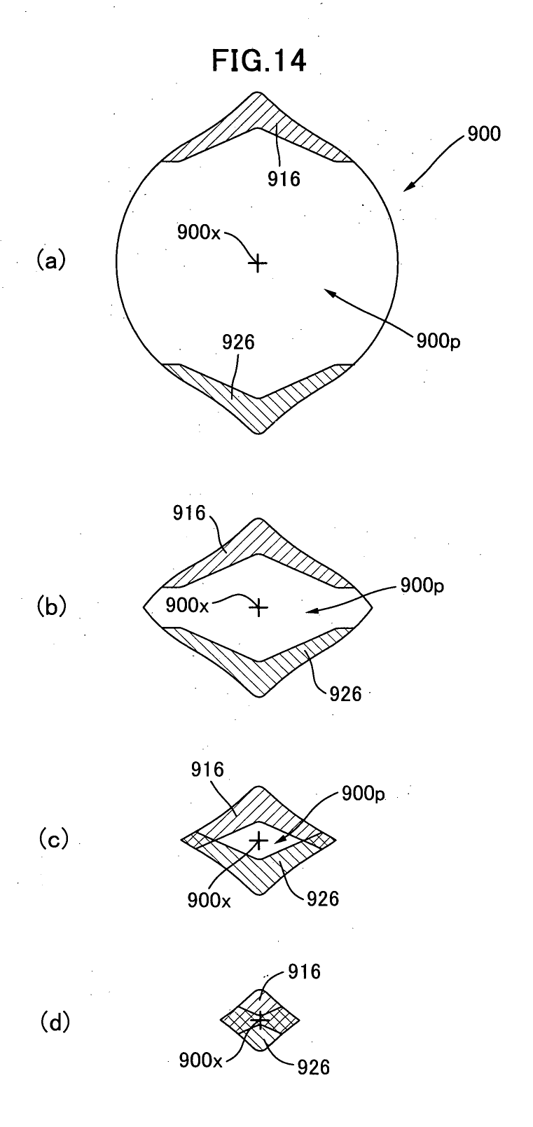

Then the stop apparatus of the second comparative example will be described. With reference to FIG. 14, a configuration of stop apparatus 900 is same as that of the stop apparatus 200 of the first embodiment of the present invention. The stop apparatus 900 has an upper blade ND filter 916 and a lower blade ND filter 926. The upper blade ND filter 916 has a value of ND 1.0. The lower blade ND filter 926 has a value of ND 1.0. The ray transmittance of the upper blade ND filter 916 is same as that of the lower blade ND filter 926. That is, the density of the upper blade ND filter 916 is same as that of the lower blade ND filter 926. The structure of the stop apparatus 900 of the second comparative example is same as that of the stop apparatus 200 of the first embodiment of the present invention except that both the ray transmittances of the upper and lower blade ND filters 916 and 926 are same.

With reference to FIG. 14, it is shown herein a condition of the stop apparatus 900 being set at the fully-opened value. When actuating the galvanometer (not shown) to move the upper blade (not shown) downward and the lower blade (not shown) upward, the configuration of the stop aperture 900p changes from FIG. 14(a) to FIGS. 11(b) and 11(c) and thus its stop area is gradually decreased. With continuing actuation of the galvanometer, the area of the stop aperture further decreases to a condition shown in FIG. 14(d). In the condition of FIG. 14(d), there are coexistence with a region in which only the upper blade ND filter 916 exists, a region in which only the lower blade ND filter 926 exists, and a region in which the upper blade ND filter 916 and the lower blade ND filter 926 are overlapped.

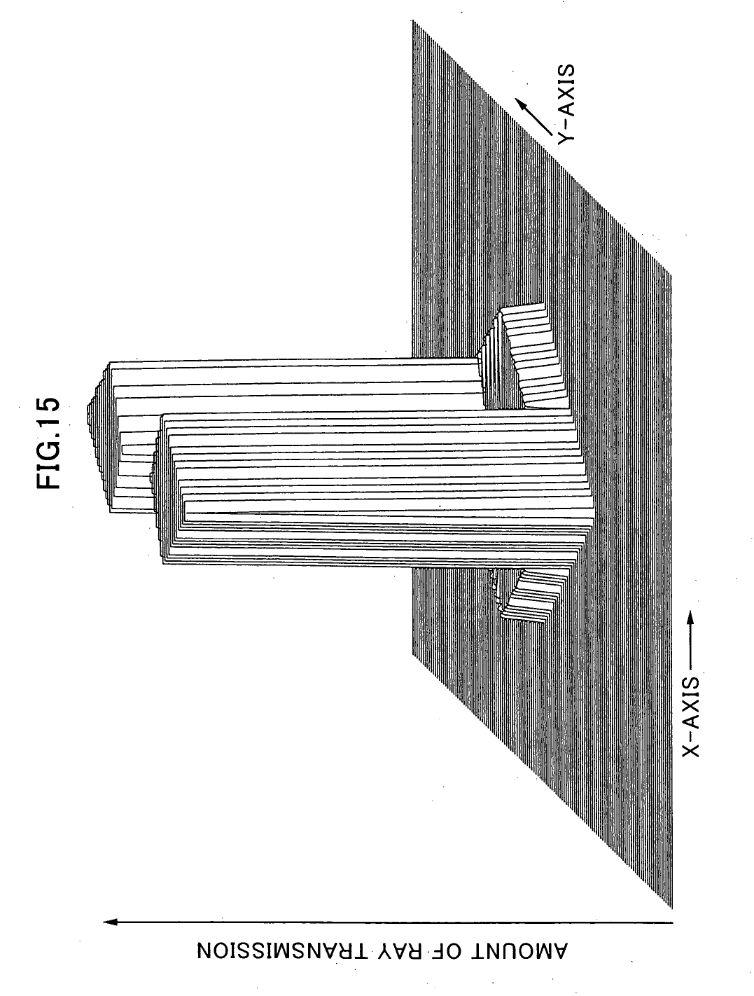

With reference to FIG. 15, it will be seen that two high intensity portions exists in the Y-axis direction at the stop opening of FIG. 14(d). These high intensity portions correspond to the region in which only the upper ND filter 916 exists and the region in which only the lower blade ND filter 926 exists, respectively.

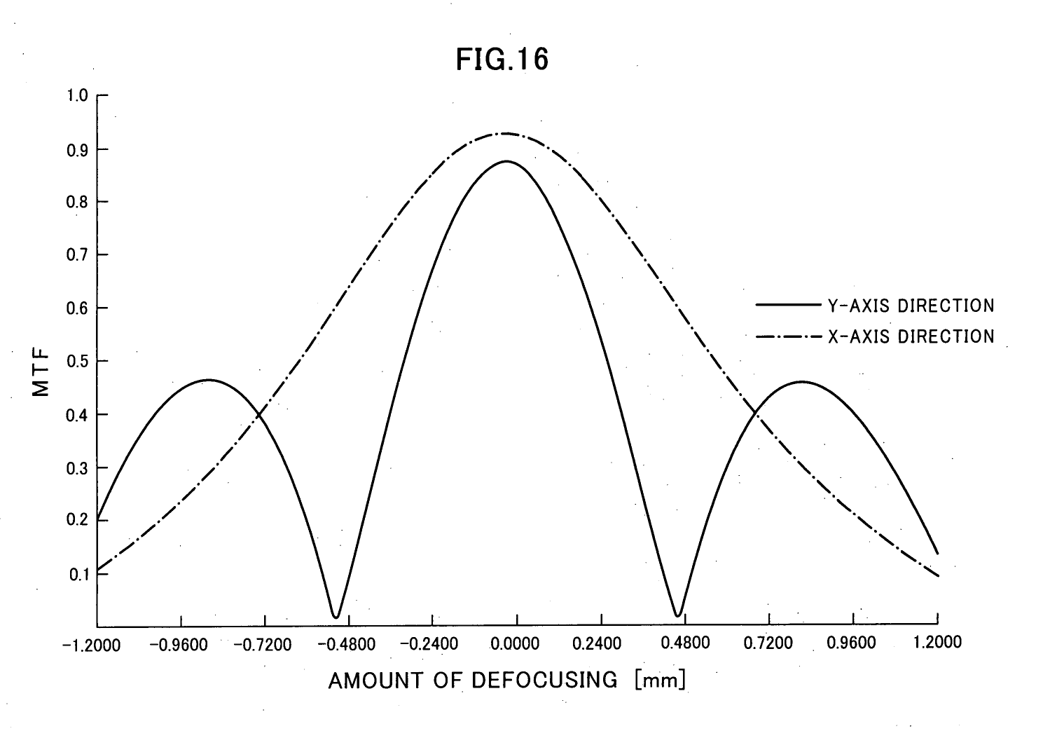

FIG. 16 is a graph showing the MTF defocusing characteristics of 10/mm in a case in which the stop apparatus having the amount distribution of ray transmission of FIG. 15 is incorporated in a video camera. This graph shows the MTF relative to each defocusing amount. In FIG. 16, a dashed line shows the defocusing characteristics or MTF in the X-direction and a solid line shows the defocusing characteristics or MTF in the Y-direction. In a case of light amount distribution of FIG. 15, contrast-peaks of false resolution appears in the defocusing characteristics or MTF in the Y-axis direction, but contrast-peaks of false resolution does not appear in the defocusing characteristics or MTF in the X-axis direction. Accordingly, it is possible to use the stop apparatus 900 of the second comparative example in combination with the auto-focusing apparatus using the horizontal image signal of video signals (the auto-focusing apparatus of so-called a “mountain-climbing type”).

However in the stop apparatus 900 of the second comparative example, the quality of image would be extremely reduced due to generation of diffraction by a micro gap between two ND filters at a stop opening just before the stop aperture being completely covered by the ND filters since the ND filters themselves act similarly to the stop blades when the ray transmittance of the ND filters is low. Accordingly, the stop apparatus of this second comparative example cannot reduce the ray transmittance of the ND filter below 10%. However, it is required in a stop apparatus of a camera having high sensitivity such as a recent video camera not to cause deterioration of quality of an image even at a level higher than F/360. Thus it is necessary to reduce the ray transmittance of the ND filter below 10% in the stop apparatus of such a high sensitivity camera. On the contrary, the stop apparatus of the present invention can reduce the ray transmittance of the ND filter below 10% without deteriorating the quality of an image.

(3•4) Conclusion of the Stop Apparatus of the Present Invention and the Comparative Examples

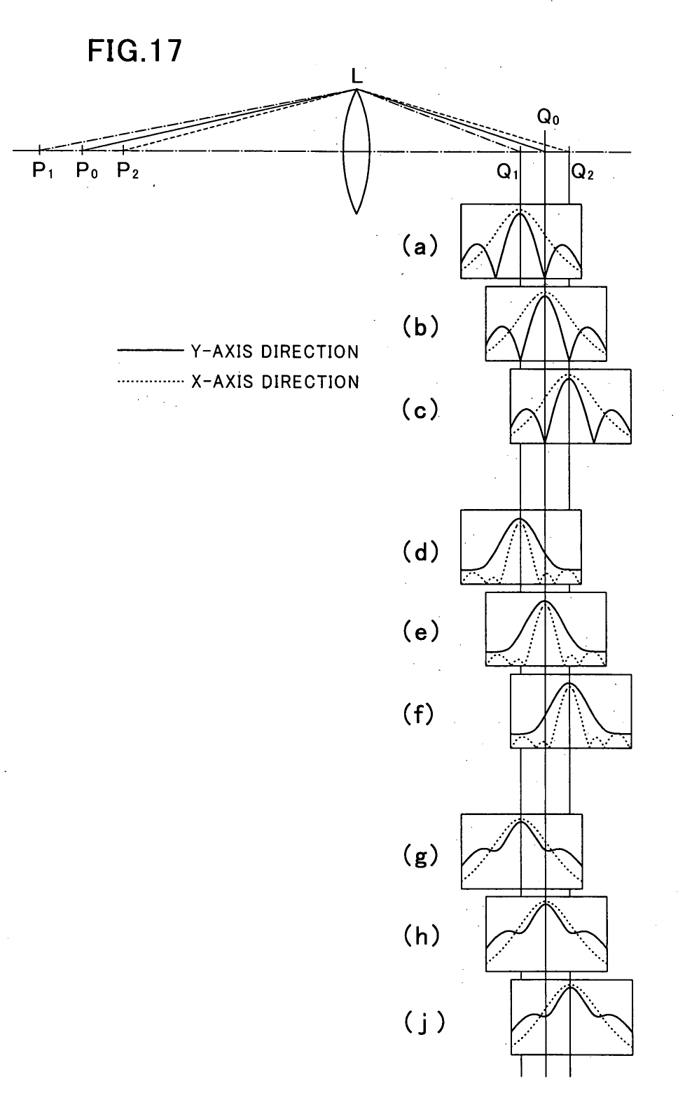

Then conclusion of the stop apparatus of the present invention and the comparative examples will be described. FIG. 17 shows the MTF defocusing characteristics of 10/mm in a case of a stop apparatus being mounted on a lens respectively as to the stop apparatus of the second comparative example (FIGS. 17(a) through (c)), the stop apparatus of the first comparative example (Figs. (d) through (f)), and the stop apparatus of the first embodiment of the present invention (Figs. (g) through (j)). In FIGS. 17(a) through (j), dashed lines show the defocusing characteristics or MTF in the X-direction and solid lines show the defocusing characteristics or MTF in the Y-direction.

FIG. 17(a) shows the defocusing characteristics or MTF at a position Q₁ at which rays emitted from P₁ image in the second comparative example.

FIG. 17(b) shows the defocusing characteristics or MTF at a position Q₀ at which rays emitted from P₀ image in the second comparative example.

FIG. 17(c) shows the defocusing characteristics or MTF at a position Q₂ at which rays emitted from P₂ image in the second comparative example.

FIG. 17(d) shows the defocusing characteristics or MTF at a position Q₁ at which rays emitted from P₁ image in the first comparative example.

FIG. 17(e) shows the defocusing characteristics or MTF at a position Q₀ at which rays emitted from P₀ image in the first comparative example.

FIG. 17(f) shows the defocusing characteristics or MTF at a position Q₂ at which rays emitted from P₂ image in the first comparative example.

FIG. 17(g) shows the defocusing characteristics or MTF at a position Q₁ at which rays emitted from P₁ image in the first embodiment of the present invention.

FIG. 17(h) shows the defocusing characteristics or MTF at a position Q₀ at which rays emitted from P₀ image in the first embodiment of the present invention.

FIG. 17(ⱼ) shows the defocusing characteristics or MTF at a position Q₂ at which rays emitted from P₂ image in the first embodiment of the present invention.

With reference to FIGS. 17(d) through (f) of the stop apparatus of the first comparative example, a plurality of peaks exist in the X-axis direction. Accordingly, it is afraid that the peaks of false resolutions are judged as focused positions and thus erroneous operation of auto-focusing would be caused if the stop apparatus of the first comparative example is applied to a camera having the auto-focusing apparatus of so-called a “mountain-climbing type”. Thus it is difficult to use the stop apparatus of the first comparative example in combination with the auto-focusing apparatus using the horizontal image signal of video signals.

On the contrary, with reference to Figs. (g) through (j) of the stop apparatus of the first embodiment of the present invention, a plurality of peaks does not exist not only in the X-axis direction but in Y-axis direction. Accordingly, in the stop apparatus of the present invention, there will be not caused any out-of-focus condition at regions away from the center of the imaging plane in the Y-axis direction. In addition, it is not afraid that peaks of false resolutions are judged as focused positions when the stop apparatus of the present invention is applied to a camera having the auto-focusing apparatus of so-called a “mountain-climbing type”. Thus it is possible to use the stop apparatus of the present invention in combination with the auto-focusing apparatus using the horizontal image signal of video signals.

In order to prevent generation of erroneous operation of the auto-focusing apparatus of so-called a “mountain-climbing type” in the stop apparatus of the present invention, it is preferable to provide a difference more than 0.2 in ND values of the ray transmittance of the upper blade ND filter relative to that of the lower blade ND filter. That is, it is preferable that there is a difference more than 1.5 times between the ray transmittance of the upper blade ND filter and that of the lower blade ND filter.

### (4) Insurance of Contrast

(4•1) The Stop Apparatus of the Embodiment of the Present Invention

Then insurance of contrast in a whole imaging plane in the embodiment of the present invention will be described. As previously mentioned, FIG. 7 is a graph showing MTF defocusing characteristics of 10/mm when the stop apparatus having the distribution of amount of ray transmission of FIG. 6 is applied to a video camera. With reference to FIG. 7, no contrast-peak of false resolution appears in the defocusing characteristics or MTF in the X-axis direction as well as the contrast-peaks of false resolution in the defocusing characteristics or MTF in the Y-axis direction are mild. That is, in the stop apparatus of the present invention, the defocus characteristics or MTF in the Y-axis direction is 0.9 with respect to the object focused in the imaging plane. Also in the stop apparatus of the present invention, the defocusing characteristics or MTF in the Y-axis direction is about 0.5 through 0.6 in regions of defocusing amount of 0.5 through 0.9 mm and −0.5 through −0.9 mm with respect to other objects situated at a distance different from the object distance (“object distance” means a distance from a camera to an object as to the focused (i.e. in-focus) object).

Under the circumstances, in order to reduce anxiety of reduction of contrast with respect to other objects situated at a distance different from the object distance, it is preferable to set the ray transmittances of the upper and lower blade ND filters so that a relative minimum value of MTF (at positions of defocusing amount of about 0.5 mm and −0.5 mm in FIG. 7) adjacent to a relative maximum value of MTF (at positions of defocusing amount of about 0.8 mm and −0.8 mm in FIG. 7) at a position of which defocusing amount being not zero (0) relative to said relative maximum value of MTF exhibits a value more than 15%.

The ray transmittances of the upper and lower blade ND filters in such a structure can be obtained by an experiment. In addition, in order to further reduce anxiety of reduction of contrast with respect to other objects situated at a distance different from the object distance, it is preferable to set the ray transmittances of the upper and lower blade ND filters so that a relative minimum value of MTF (at positions of defocusing amount of about 0.5 mm and −0.5 mm in FIG. 7) adjacent to a relative maximum value of MTF (at positions of defocusing amount of about 0.8 mm and −0.8 mm in FIG. 7) at a position of which defocusing amount being not zero (0) relative to said relative maximum value of MTF exhibits a value more than 30%. It is more preferable to set the ray transmittances of the upper and lower blade ND filters so that said value becomes a value more than 50%.

It is particularly preferable that such value of the MTF satisfies both the defocusing characteristics or MTF in the X-axis direction and the defocusing characteristics or MTF in the Y-axis direction with respect to other objects situated at a distance different from the object distance of a focused object. That is, in the stop apparatus of the present invention, the ray transmittance of the first optical filter (i.e. the upper blade ND filter) is different from that of the second optical filter (i.e. the lower blade ND filter) so that the contrast reduction of an object is prevented with respect to other objects situated at a distance different from the object distance the focused object with keeping the contrast of object focused in the imaging plane high. This arrangement of the stop apparatus of the present invention makes it possible to ensure a sufficiently high value of the contrast of object, and simultaneously to ensure a sufficiently high value with respect to other objects at a distance different from the object distance of the focused object.

(4•2) The Stop Apparatus of the First Comparative Example

Then a condition of contrast in a whole imaging plane in the first comparative example of the present invention will be described. As previously mentioned, FIG. 13 is a graph showing MTF defocusing characteristics of 10/mm when the stop apparatus having the distribution of amount of ray transmission of FIG. 12 is mounted on a video camera. With reference to FIG. 13, the contrast-peaks in the defocusing characteristics or MTF in the Y-axis direction are mild. However in the first comparative example, although the defocus characteristics or MTF in the X-axis direction is about 0.9 with respect to the object focused in the imaging plane, the MTF is about 0 through 0.02 with respect to regions having a defocusing amount of 0.3 mm, 0.55 mm, −0.3 mm and −0.55 mm. That is, in the stop apparatus of first comparative example, it is afraid that the contrast of other objects situated at a distance different from the object distance of the focused object with respect to the resolution in X-axis direction of the imaging plane would be largely reduced.

(4•3) The Stop Apparatus of the Second Comparative Example

Then a condition of contrast in a whole imaging plane in the second comparative example of the present invention will be described. As previously mentioned, FIG. 16 is a graph showing MTF defocusing characteristics of 10/mm when the stop apparatus having the distribution of amount of ray transmission of FIG. 15 is mounted on a camera having an auto-focusing apparatus. With reference to FIG. 16, the contrast-peaks in the defocusing characteristics or MTF in the X-axis direction are mild. However in the second comparative example, although the defocus characteristics or MTF in the Y-axis direction is about 0.9 with respect to the object focused in the imaging plane, the MTF is about 0 through 0.02 with respect to regions of defocusing amount being 0.5 mm and −0.5 mm. That is, in the stop apparatus of first comparative example, it is afraid that the contrast of other objects situated at a distance different from the object distance of the focused object with respect to the resolution in Y-axis direction of the imaging plane would be largely reduced.

(4•4) Conclusion of the Stop Apparatus of the Present Invention and the Comparative Examples

Then conclusion of the stop apparatus of the present invention and the comparative examples will be described. With reference to FIG. 17(a), in the second comparative example the rays emitted from the point P₁ image at the point Q₁ and the defocusing characteristics or MTF at the point Q₀ zero (0). Further with reference to FIG. 17(c), in the stop apparatus of the second comparative example the rays emitted from the point P₂ image at the point Q₂ and the defocusing characteristics or MTF at the point Q₀ is zero (0). Accordingly, in the stop apparatus of the second comparative example, although the contrast of object is high with respect to the object focused in the imaging plane, the contrast of other objects situated at a distance different from the object distance of the focused object with respect to the resolution in Y-axis direction of the imaging plane would be reduced. That is, when imaging an object by a video camera using the stop apparatus of the second comparative example, a high contrast image is recorded only with respect to the object focused in a imaging plane with respect to the resolution in Y-axis direction of the imaging plane,however it is afraid that a low contrast image would be recorded with respect to other objects situated at a distance different from the object distance of the focused object.

With reference to FIG. 17(d), in the first comparative example the rays emitted from the point P₁ image at the point Q₁ and the defocusing characteristics or MTF at the point Q₀ is zero (0). Further with reference to FIG. 17(f), in the stop apparatus of the first comparative example the rays emitted from the point P₂ image at the point Q₂ and the defocusing characteristics or MTF at the point Q₀ is zero (0). Accordingly, in the stop apparatus of the first comparative example, although the contrast of object is high with respect to the object focused in the imaging plane, the contrast of other objects situated at a distance different from the object distance of the focused object with respect to the resolution in X-axis direction of the imaging plane would be reduced. That is, when imaging an object by a video camera using the stop apparatus of the first comparative example, it is afraid that a high contrast image is recorded only with respect to the object focused in a imaging plane with respect to the resolution in X-axis direction of the imaging plane and it is afraid a low contrast image would be recorded with respect to other objects situated at a distance different from the object distance of the focused object.

The present invention has been described with reference to the preferred embodiment. Obviously, modifications and alternations will occur to those of ordinary skill in the art upon reading and understanding the preceding detailed description. It is intended that the present invention be construed as including all such alternations and modifications insofar as they come within the scope of the appended claims or the equivalents thereof. Especially, a camera to which the stop apparatus of the present invention is applied may be any camera other than a video camera.

1. A stop apparatus for controlling an amount of passing light of luminous flux from an object passing through an imaging lens comprising;
a first stop blade having a first stop aperture for controlling the amount of passing light of luminous flux from the object;
a first optical filter mounted on a portion of the first stop aperture of the first stop blade;
a second stop blade having a second stop aperture for controlling the amount of passing light of luminous flux from the object;
a second optical filter mounted on a portion of the second stop aperture of the second stop blade;
a support member for supporting the first and second stop blades to be linearly movable;
an actuator for linearly driving the first stop blade in a first direction and for linearly driving the second stop blade in a second direction opposite to the first direction; and
the ray transmittance of the first optical filter is different from that of the second optical filter so as to prevent reduction of the contrast of an other object situated at a distance different from the object distance of the focussed object.

2. A stop apparatus of claim 1 wherein there is a difference in the ray transmittance more than 1.5 times between the first optical filter and the second optical filter.

3. A stop apparatus of claim 1 wherein the ray transmittances of the first and second optical filters are set so that a relative minimum value of MTF adjacent to a relative maximum value of MTF at a position at which an amount of defocusing is not zero (0) becomes a value 15%” larger than said relative maximum value of MTF.

4. A stop apparatus of claim 1 wherein the configuration of an edge forming the stop aperture of the first and/or second optical filter(s) is concave.

5. A stop apparatus of claim 1 wherein one of the configurations of edges forming the stop apertures of the first and second optical filters is concave and the other of them is straight.

6. A stop apparatus of claim 1 wherein the first and/or second optical filter(s) is formed by an ND filter.

7. A stop apparatus of claim 1 wherein the first and second optical filters are partially overlapped when the stop apparatus is largely stopped down.

8. A lens of an optical instrument comprising a stop apparatus for controlling an amount of passing light of luminous flux from an object passing through an imaging lens defined in claim 1.

9. A video camera comprising:
an imaging lens for imaging a luminous flux from an object;
a camera body for recording the luminous flux from the object passing through the imaging lens;
a stop apparatus for controlling an amount of passing light of the luminous flux from the object passing through the imaging lens defined in claim 1.
